(19) United States
(12) Patent Application Publication
(10) Pub. No.: US 2008/0025390 A1
(43) Pub. Date: Jan. 31, 2008

(54) ADAPTIVE VIDEO FRAME INTERPOLATION

(76) Inventors: Fang Shi, San Diego, CA (US); Vijayalakshmi R. Raveendran, San Diego, CA (US); Min Dai, Encinitas, CA (US)

Correspondence Address: QUALCOMM INCORPORATED, 5775 MOREHOUSE DR., SAN DIEGO, CA, 92121, US

(21) Appl. No.: 11/620,022

(22) Filed: Jan. 4, 2007

Related U.S. Application Data
(60) Provisional application No. 60/833,437, filed on Jul. 25, 2006.

(51) Int. Cl. H04B 1/66

(52) U.S. Cl. 375/240.02; 375/240.12; 375/240.16

(57) ABSTRACT

In general, this disclosure is directed to decoding techniques for interpolating video frames. In particular, the techniques of this disclosure may be used to dynamically adjust a frame interpolation operation based on analysis of information associated with one or more video frames. In response to the analysis of the information associated with one or more frames, the interpolation control module adjusts the frame interpolation operation in number of different manners. For example, the interpolation control module may dynamically enable or disable motion compensated frame interpolation, select a different type of interpolation, select a video frame prediction mode to be used in the motion compensated frame interpolation, or select different threshold values for frame interpolation.

This application claims the benefit of U.S. Provisional Application No. 60/833,437 (Docket No. 060955P1), filed on Jul. 25, 2006, the entire content of which is incorporated herein by reference.

### TECHNICAL FIELD

This disclosure relates to digital video encoding and decoding and, more particularly, techniques for interpolation of video frames.

### BACKGROUND

Digital video capabilities can be incorporated into a wide range of devices, including digital televisions, digital direct broadcast systems, wireless communication devices, personal digital assistants (PDAs), laptop computers, desktop computers, video game consoles, digital cameras, digital recording devices, cellular or satellite radio telephones, and the like. Digital video devices can provide significant improvements over conventional analog video systems in processing and transmitting video sequences.

Different video encoding standards have been established for encoding digital video sequences. The Moving Picture Experts Group (MPEG), for example, has developed a number of standards including MPEG-1, MPEG-2 and MPEG-4. Other examples include the International Telecommunication Union (ITU)-T H.263 standard, and the ITU-T H.264 standard and its counterpart, ISO/IEC MPEG-4, Part 10, i.e., Advanced Video Coding (AVC). These video encoding standards support improved transmission efficiency of video sequences by encoding data in a compressed manner.

Various video encoding standards support video encoding techniques that utilize similarities between successive video frames, referred to as temporal or Inter-frame correlation, to provide Inter-frame compression. The Inter-frame compression techniques exploit data redundancy across frames by converting pixel-based representations of video frames to motion representations. Frames encoded using Inter-frame techniques are referred to as P (“predictive”) frames or B (“bi-directional”) frames. Some frames, referred to as I (“intra”) frames, are encoded using spatial compression, which are non-predictive.

In order to meet low bandwidth requirements, some video applications, such as video telephony or video streaming, reduce the bit rate by encoding video at a lower frame rate using frame skipping. Unfortunately, the reduced frame rate video can produce artifacts in the form of motion jerkiness. Therefore, frame interpolation, also known as frame rate up conversion (FRUC), can be used at the decoder to interpolate the content of skipped frames, and thereby provide the effect of increased frame rate at the decoder side.

### SUMMARY

In general, this disclosure is directed to decoding techniques for interpolating video frames. In particular, the techniques of this disclosure may be used to dynamically adjust a frame interpolation operation based on analysis of information associated with one or more video frames. The dynamic frame interpolation adjustment techniques described in this disclosure may result in more efficient and effective decoding of frames.

In one aspect, a method for processing digital video data comprises analyzing information associated with at least one video frame and dynamically adjusting a frame interpolation operation based on the analysis of the information.

In another aspect, an apparatus for processing digital video data comprises an an analysis module that analyzes information associated with at least one video frame and an adjustment module that dynamically adjusts the frame interpolation operation based on the analysis of the information.

In a further aspect, an apparatus for processing digital video data comprises means for analyzing information associated with a video frame and means for dynamically adjusting a frame interpolation operation based on the analysis of the information.

In yet another aspect, a computer-program product for processing digital video data comprise a computer readable medium comprising codes for causing at least one computer to analyze information associated with at least one video frame and dynamically adjust a frame interpolation operation based on the analysis of the information.

In another aspect a processor for processing digital video data is adapted to analyze information associated with at least one video frame and dynamically adjust a frame interpolation operation based on the analysis of the information.

The techniques described in this disclosure may be implemented in hardware, software, firmware, or any combination thereof. If implemented in software, the software may be executed in a computer. The software may be initially stored as instructions, program code, or the like. Accordingly, the disclosure also contemplates a computer program product for digital video encoding comprising a computer-readable medium, wherein the computer-readable medium comprises codes for causing a computer to execute techniques and functions in accordance with this disclosure.

The details of one or more aspects of the disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 is a block diagram illustrating a video encoding and decoding system that employs adaptive frame interpolation techniques in accordance with this disclosure.

FIG. 2 is a block diagram illustrating an exemplary interpolation decoder module for use in a video decoder.

FIG. 3 is a flow diagram illustrating exemplary operation of an interpolation decoder module dynamically adjusting a frame interpolation operation based on analysis of content of one or more video frames, regularity of a motion field between one or more video frames, coding complexity associated with one or more video frames, or a combination thereof.

FIG. 4 is a flow diagram illustrating exemplary operation of an interpolation decoder module dynamically adjusting a frame interpolation operation based on analysis of a frame information table (FIT).

FIG. 5 is a flow diagram illustrating exemplary operation of interpolation decoder module adjusting a frame interpolation operation based on an analysis of moving objects within one or more video frames.

FIG. 6 is a flow diagram illustrating exemplary operation of moving object detection module analyzing block information associated with blocks of pixels of a frame to detect moving objects in the frame.

### DETAILED DESCRIPTION

Various aspects of the disclosure are described below. It should be apparent that the teachings herein may be embodied in a wide variety of forms and that any specific structure or function disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure or functionality in addition to or other than one or more of the aspects set forth herein. Thus, an apparatus may be implemented or a method practiced that utilizes one or more of the dynamic frame interpolation adjustment techniques disclosed herein to more efficiently and effectively decode frames.

In general, this disclosure is directed to decoding techniques for interpolating video frames. In particular, the techniques of this disclosure may be used to dynamically adjust a frame interpolation operation based on analysis of information associated with one or more video frames. The dynamic frame interpolation adjustment techniques described in this disclosure may result in more efficient and effective decoding of frames.

An interpolation decoder module may, for example, video frames based on one or more reference video frames. The interpolation decoder module may interpolate video frames to up-convert an original intended frame rate from the encoder. Alternatively, the interpolation decoder module may interpolate video frames to insert one or more video frames that were skipped by the video encoder to encode video information at a reduced frame rate. The interpolation decoder module may interpolate the video frames using any of a number of interpolation techniques, e.g., using motion compensated frame interpolation, frame repeat, or frame averaging. In accordance with the techniques of this disclosure, the interpolation decoder module analyzes information associated with one or more video frames and dynamically adjusts the frame interpolation operation based on the analysis.

The interpolation decoder module may, for example, analyze content of one or more video frames, regularity of a motion field between two or more video frames, coding complexity associated with one or more video frames, or a combination thereof. In one example, the interpolation decoder module may analyze information associated with one or more reference frames. Alternatively, or additionally, the interpolation decoder module may analyze information associated with a frame-to-be-interpolated, such as a skipped frame. The interpolation decoder module may also analyze information for a plurality of frames received over a period of time, e.g., frames received over a one-second interval.

The interpolation decoder module dynamically adjusts the frame interpolation operation based on the analysis of the information associated with the one or more video frames. The interpolation decoder module may adjust the frame interpolation operation in number of different manners. As an example, the interpolation decoder module may select whether to enable or disable motion compensated frame interpolation. When motion compensated frame interpolation is disabled, the interpolation decoder module may select a different frame interpolation operation, such as a frame repeat or a frame average operation. As another example, the interpolation decoder module may select a video frame prediction mode to be used in the motion compensated frame interpolation based on the analysis. In a further example, the interpolation decoder module may assign different threshold values for frame interpolation based on the analysis.

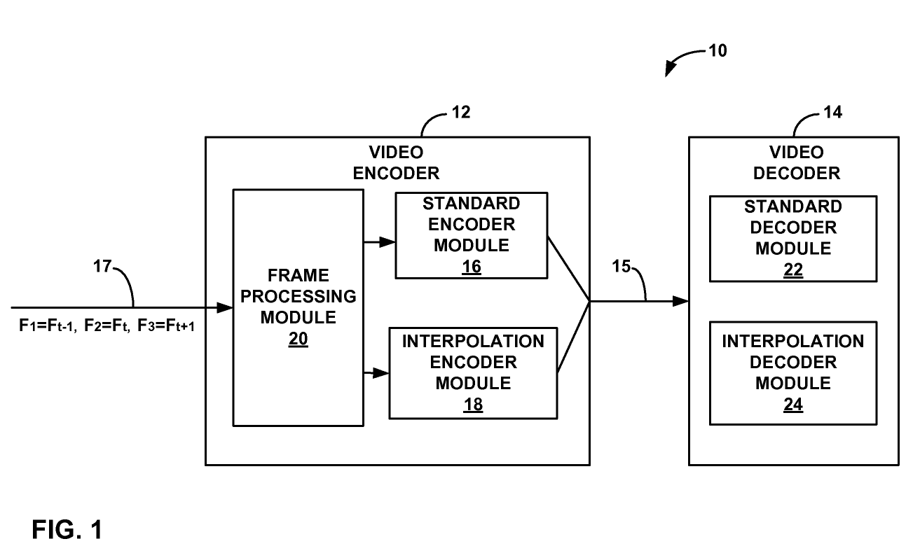

FIG. 1 is a block diagram illustrating a video encoding and decoding system 10 that employs adaptive frame interpolation techniques in accordance with this disclosure. As shown in FIG. 1, system 10 includes a video encoder 12 and a video decoder 14 connected by a transmission channel 15. Encoded multimedia sequences, such as video sequences, may be transmitted from encoder 12 to decoder 14 over transmission channel 15. Transmission channel 15 may be a wired or wireless medium. System 10 may support bi-directional video transmission, e.g., for video telephony. Accordingly, reciprocal encoding and decoding components may be provided on opposite ends of channel 15. Alternatively, system 10 may support broadcasting and video encoder 12 may form part of a video broadcast device that broadcasts or streams video to one or more subscriber devices over a wired or wireless media. In various aspects, video encoder 12 and video decoder 14 may be embodied within video communication devices such as a digital television, a wireless communication device, a gaming device, a portable digital assistant (PDA), a laptop computer or desktop computer, a digital music and video device, such as those sold under the trademark “iPod,” or a radiotelephone such as cellular, satellite or terrestrial-based radiotelephone, or other wireless mobile terminals equipped for video streaming, video telephony, or both.

In some aspects, for two-way communication, system 10 may support video telephony or video streaming according to the Session Initiated Protocol (SIP), ITU-T H.323 standard, ITU-T H.324 standard, or other standards. Video encoder 12 generates encoded video data according to a video compression standard, such as MPEG-2, MPEG-4, ITU-T H.263, or ITU-T H.264. Although not shown in FIG. 1, video encoder 12 and video decoder 14 may be integrated with an audio encoder and decoder, respectively, and include appropriate multiplexer-demultiplexer (MUX-DEMUX) units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP). In some aspects, this disclosure contemplates application to Enhanced H.264 video coding for delivering real-time video services in terrestrial mobile multimedia multicast (TM3) systems using the Forward Link Only (FLO) Air Interface Specification, “Forward Link Only Air Interface Specification for Terrestrial Mobile Multimedia Multicast,” to be published as Technical Standard TIA-1099 (the “FLO Specification”). However, the frame interpolation techniques described in this disclosure are not limited to any particular type of broadcast, multicast system, or point-to-point system.

Video encoder 12 and video decoder 14 may be implemented as one or more processors, digital signal processors (DSPs), application specific integrated circuits (ASICs), field programmable gate arrays (FPGAs), discrete logic, software, hardware, firmware or any combinations thereof. The illustrated components of video encoder 12 and video decoder 14 may be included in one or more encoders or decoders, either of which may be integrated as part of a combined encoder/decoder (CODEC) in a respective subscriber device, broadcast device, server, or the like. In addition, video encoder 12 and video decoder 14 may include appropriate modulation, demodulation, frequency conversion, filtering, and amplifier components for transmission and reception of encoded video, including radio frequency (RF) wireless components and antennas, as applicable. For ease of illustration, however, such components are not shown in FIG. 1.

Encoder 12 receives an input multimedia sequence 17 and selectively encodes the multimedia sequence 17. Multimedia sequence 17 may be a live real-time video or video and audio sequence that is captured by a video source (not shown). Alternatively, multimedia sequence may be a pre-recorded and stored video or video and audio sequence. In either case, encoder 12 encodes and transmits a plurality of video frames to decoder 14. The plurality of video frames may include one or more intra (“I”) frames that are encoded without reference to other frames, predictive (“P”) frames that are encoded with reference to temporally prior frames, bi-directional (“B”) frames that are encoded with respect to temporally prior and future frames, or a combination thereof. The encoded frames include sufficient information to permit video decoder 14 to decode and present a frame of video information. Encoder 12 may encode the frames to include one or more motion vectors, an encoding mode used to encode each block of pixels, sub-partitions of each block of pixels, coefficients within each block of pixels, number of non-zero coefficients within each block of pixels, skip or direct block numbers, and the like.

In some aspects of this disclosure, video encoder 12 may encode the video information contained in video sequence 14 at a reduced frame rate using frame skipping to conserve bandwidth across transmission channel 15. To encode video information at a reduced frame rate, encoder 12 may skip particular frames (referred to as skipped (“S”) frames) according to a frame skipping function designed to reduce the overall amount of encoded information for bandwidth conservation across transmission channel 15. In other words, encoder 12 does not actually encode and transmit the S frames. Instead, video decoder 14 interpolates the skipped frames using one or more of the transmitted frames, referred to herein as reference frames, to produce a frame of video information. This interpolation process has the effect of increasing the apparent frame rate of the video decoded by decoder 15, and is often referred to as frame rate up-conversion (FRUC).

In the example of FIG. 1, video encoder 12 includes a frame processing module 20, a standard encoder module 16 and an interpolation encoded module 18. Frame processing module 20 is configured to process incoming frames of video information, such as frames F₁, F₂ and F₃. Based on analysis of incoming frames F₁, F₂ and F₃, frame processing module 20 determines whether to encode or skip the incoming frames. In the example of FIG. 1, F₂ represents the frame to be skipped, while frames F₁ and F₃ represent the previous and subsequent frames, respectively, which will be encoded and transmitted to video decoder 14. Although in the example illustrated in FIG. 1 frame processing module 20 skips every other frame, frame processing module 20 may be configured to skip every n^{th} frame or include a dynamic skipping criteria that may be applied to dynamically select frames to be skipped. For the incoming frames that will be encoded, frame processing module 20 may also be configured to determine whether to encode the frames as I frames, P frames or B frames.

Frame processing module 20 may be further configured to partition a frame into N blocks of pixels and encode each of the blocks of pixels separately. As an example, frame processing unit 20 may partition the frame in a plurality of 16×16 blocks of pixels. Some blocks of pixels, often referred to as “macroblocks,” comprise a grouping of sub-blocks of pixels. As an example, a 16×16 macroblock may comprise four 8×8 sub-blocks. The sub-blocks may be encoded separately. For example, the H.264 standard permits encoding of blocks with a variety of different sizes, e.g., 16×16, 16×8, 8×16, 8×8, 4×4, 8×4, and 4×8. In this manner, frame processing module 20 may be configured to divide the frame into several blocks of pixels and determine whether to encode each of the blocks as I-frames, P-frames or B-frames.

Standard encoding module 16 applies standard encoding techniques, such as motion estimation and motion compensation, to encode frames or blocks of pixels in the frame selected by frame processing module 20 for encoding, e.g., frames F₁ and F₃. Standard encoding module 16 may also apply non-motion coding techniques such as spatial estimation and intra-prediction for some of the frames or blocks of pixels. According to standard predictive-based techniques, standard encoding module 16 may also include various units for entropy encoding, scanning, quantization, transformation, and possibly deblock filtering.

In some aspects, video encoder 12 may also include an interpolation encoder module 18. Interpolation encoder module 18 may generate and encode information associated with the skipped frames to assist decoder 14 in interpolating the skipped frames. Interpolation encoder module 18 may generate and transmit, for example, motion information for one or more skipped frames or one or more blocks of pixels in the skipped frame, information identifying a prediction mode used for encoding the blocks in the skipped frame, and the like. Interpolation encoder module 18 may transmit the encoded information associated with the skipped frames to video decoder 14 in a dedicated frame or as information embedded in one or more transmitted video frames, such as frame F₁ or F₃. In this manner, video encoder 12 may be configured in some aspects, to generate and transmit information associated with the skipped frame to assist video decoder 14 in interpolating the skipped frame. However, the techniques described in this disclosure may not require assistance from video encoder 12. Thus, in some aspects, video encoder 12 may not include an interpolation encoder module 18. In this case, video decoder 14 performs interpolation without the assistance of video encoder 12.

Video decoder 14 receives the encoded video frames from video encoder 12 and decodes the video frames. Video decoder 14 includes a standard decoder module 22 and an interpolation decoder module 24. Standard decoder module 22 and interpolation decoder module 24 need not be separate components, and instead may be integrated as separate processes within a common CODEC, making use of multiple components on a shared basis. Standard decoder module 22 applies standard decoding techniques to decode each encoded frame, such as frames F₁ and F₃, transmitted by encoder 12. As described above, the information encoded in each frame is sufficient to permit standard decoder module 22 to decode and present a frame of video information.

Interpolation decoder module 24 interpolates video frames based on one or more reference frames of video data. In other words, interpolation decoder module 24 may use encoded information associated with one or more reference video frames, such as frames F₁, F₃ or both, to interpolate the video frames. As described above, interpolation decoder module 24 may interpolate video frames, such as frame F₂, skipped by encoder 12 to conserve bandwidth. Alternatively, interpolation decoder module 24 may interpolate video frames to insert one or more video frames in order to up-convert the frame rate of the video information. Interpolation decoder module 24 may interpolate the video frames using any of a number of interpolation techniques. For example, interpolation decoder module 24 may interpolate the video frame using a frame repeat operation, a frame averaging operation, a motion compensated frame interpolation operation or other frame interpolation operation.

In accordance with the techniques of this disclosure, interpolation decoder module 24 analyzes information associated with at least one video frame and dynamically adjusts the frame interpolation based on the analysis. Interpolation decoder module 24 may, for example, analyze content of one or more video frames, regularity of a motion field between two or more video frames, a coding complexity associated with one or more video frames, or a combination thereof. In one example, interpolation decoder module 24 may analyze information associated with one or more reference frames (e.g., F₁, F₃ or both) that are used to interpolate a video frame. Alternatively, or additionally, interpolation decoder module 24 may analyze information associated with a frame-to-be-interpolated, such as a skipped video frame. Interpolation decoder module 24 may also analyze information for a plurality of frames received over a period of time, e.g., frames received over a one-second interval. The information associated with the one or more video frames may be encoded within the video frames received from encoder 12. Alternatively, interpolation decoder module 24 may generate at least a portion of the information associated with the video frames.

Interpolation decoder module 24 dynamically adjusts a frame interpolation operation based on the analysis of the information associated with the one or more video frames. Interpolation decoder module 24 may adjust the frame interpolation operation in number of different manners. As an example, interpolation decoder module 24 may select whether to enable or disable motion compensated frame interpolation. When motion compensated frame interpolation is disabled, interpolation decoder module 24 may additionally select a different frame interpolation operation, such as a frame repeat or a frame average operation. As another example, interpolation decoder module 24 may select a video frame prediction mode to be used for frame interpolation based on the analysis. In a further example, interpolation decoder module 24 may assign different threshold values for frame interpolation based on the analysis.

The foregoing techniques may be implemented individually, or two or more of such techniques, or all of such techniques, may be implemented together in interpolation decoder module 24. A number of other elements may also be included encoding and decoding system 10, but are not specifically illustrated in FIG. 1 for simplicity and ease of illustration. The architecture illustrated in FIG. 1 is merely exemplary, as the techniques described herein may be implemented with a variety of other architectures. Moreover, the features illustrated in FIG. 1 may be realized by any suitable combination of hardware, software components, or a combination thereof. Although described in the context of interpolating skipped video frames, the techniques of this disclosure may be utilized to interpolate a video frame encoded at a reduced quality to generate a higher quality video frame.

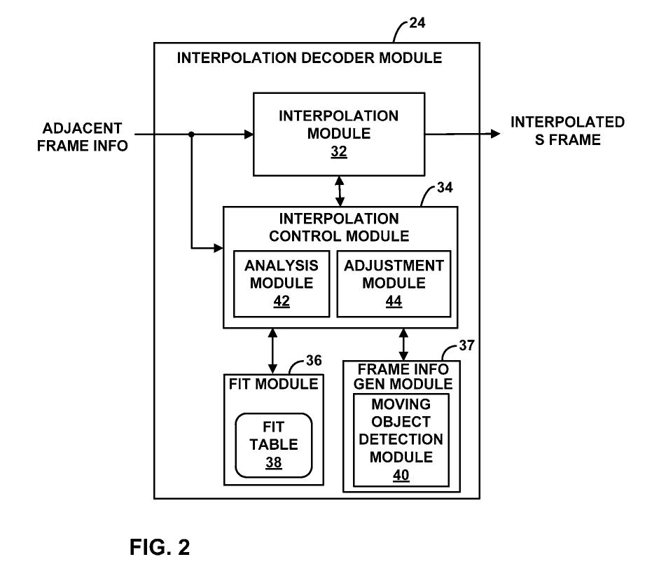

FIG. 2 is a block diagram illustrating an exemplary interpolation decoder module 24 for use in a video decoder, such as video decoder 14 of FIG. 1. Interpolation decoder module 24 includes an interpolation module 32, an interpolation control module 34, a frame information table (FIT) module 36 and a frame information generation module 37 (labeled “FRAME INFO GEN MODULE” in FIG. 2) that operate together to produce an interpolated frame. As described above, interpolation decoder module 24 analyzes information associated with at least one video frame and dynamically adjusts a frame interpolation operation based on the analysis of the information in accordance with one or more of the techniques described in this disclosure.

Interpolation module 32 interpolates a video frame based on one more reference frames. For example, interpolation module 32 may interpolate the video frame based on frame information associated with a previous reference frame, a subsequent reference frame, both a previous and subsequent reference frame, or more than two reference frames. Interpolation module 32 may interpolate frames using any of a number of interpolation techniques, such as a frame repeat operation, a frame averaging operation, a motion compensated frame interpolation operation, or a combination thereof. The motion compensated frame interpolation operation may involve any of a variety of interpolation techniques such as bilinear interpolation, bicubic interpolation, nearest neighbor interpolation, or other techniques. As described above, interpolation module 32 may be configured to interpolate frames in a block-based mode. In other words, interpolation module 32 may divide the frames into a plurality of blocks of pixels and interpolate each of the blocks of pixels separately based on information associated with corresponding blocks of pixels in the one or more reference frames. The pixels in the blocks are represented in the pixel domain while the blocks may be represented in a transform domain.

In accordance with the techniques of this disclosure, interpolation control module 34 analyzes information associated with at least one video frame and adjusts a frame interpolation operation of interpolation module 32 based on the analysis. In the example illustrated in FIG. 2, interpolation control module 34 includes an analysis module 42 that analyzes information associated with at least one video frame and an adjustment module 44 that dynamically adjusts a frame interpolation operation of interpolation module 32 based on the analysis. Interpolation control module 34 may analyze information associated with one or more reference frames. Alternatively, or additionally, interpolation control module 34 may analyze information associated with a frame-to-be-interpolated, such as a skipped frame. Interpolation control module 34 may also analyze information for a plurality of frames received over a particular period of time, e.g., frames received over a one-second interval.

The information associated with the one or more video frames may be encoded within the video frames received from encoder 12. Alternatively, frame information generation module 37 may generate at least a portion of the information associated with the frames. As one example, frame information generation module may estimate motion for one or more reference frames using conventional motion estimation techniques. As another example, frame information generation module 37 may generate motion information, e.g., motion vectors (MVs), for the frame-to-be-interpolated using motion information associated with one or more reference frames adjacent to the interpolated video frame.

Frame information generation module 37 may include a moving object detection module 40 that generates information associated with one or more moving objects within a frame. In particular, moving object detection module 40 analyzes motion vectors associated with a plurality of blocks of pixels in the frame to detect one or more moving objects within the frame. Moving object detection module 40 may, for example, group blocks of pixels within a region that have substantially similar motion vectors to identify one or more moving objects in the frame. Moreover, moving object detection module 40 may generate information associated with each of the detected moving objects. For example, moving object detection module 40 may generate information describing the size of the moving objects within the frame, the number of moving objects within the frame, motion information associated with the detected moving objects and the like.

In one aspect of this disclosure, interpolation control module 34 analyzes content of one or more video frames, regularity of a motion field between one or more video frames, coding complexity associated with one or more video frames, or a combination thereof. Interpolation control module 34 may, for example, analyze motion within the frames, texture of objects within the frames, types of video in the frames, or the like to determine the content of the frames. In particular, interpolation control module 34 may analyze a motion metric, such as one or more motion vectors, associated with the frame to determine the content of the frame. Additionally, interpolation control module 34 may analyze information associated with one or more moving objects within the frames, e.g., the information generated by moving object detection module 40, to determine the content of the frames. Interpolation control module 34 may, for example, analyze the number of moving objects within the frame or frames, the size of the moving objects within the frame or frames, and motion vectors associated with the identified moving objects to determine the content of the frames.

Moreover, interpolation control module 34 may further analyze a texture metric, such as contrast ratio values, to determine the content of the frames. Additionally, interpolation control module 34 may analyze an input frame rate to determine whether the content of the frames is natural or synthetic video. For example, a video channel, such as a cartoon channel that has synthetic video, may have an input frame rate of 13 frames per second. Such a frame rate is not typically seen in natural video transmission. In some aspects, interpolation control module 34 may classify the content of the frames based on the analysis of motion, texture, video type, and any other content characteristics. As an example, interpolation control module 34 may classify the content of the frames using a classification metric, such as rate-distortion (R-D) curves.

Alternatively, or additionally, interpolation control module 34 may analyze the regularity of the motion field between two or more frames. Interpolation control module 34 may, for example, analyze a difference metric, such as a sum of squares difference (SSD) or a sum of absolute differences (SAD), to determine the motion regularity between one or more frames. Interpolation control module 34 may also analyze the information associated with moving objects, e.g., information generated by moving object detection module 40, to determine the regularity of the motion field between two or more frames. For example, interpolation control module 34 may compare the number of moving objects, the size of the moving objects, or both in one or more frames to determine the regularity of the motion field between two or more frames.

Moreover, interpolation decoder module 24 may also analyze a coding complexity associated with one or more frames. Interpolation control module 34 may, for example, analyze the coding coefficients provided in the information associated with the frames or the number of non-zero coefficients in the information associated with the frames to determine a coding complexity associated with the frame. When the number of non-zero coefficients is large, which may indicate encoding of a large amount of residual information, interpolation control module 34 may determine that coding complexity is high. Interpolation control module 34 may, for example, select a prediction mode that uses a lower complexity frame for interpolation.

Interpolation decoder module 24 dynamically adjusts a frame interpolation operation based on the analysis the content of one or more video frames, the regularity of a motion field between one or more video frames, the coding complexity associated with one or more video frames, or a combination thereof. As one example, interpolation control module 34 may dynamically adjust threshold parameters used by interpolation module 32 based on the analysis of the content, regularity of the motion field, coding complexity associated with one or more frames, or a combination thereof. Interpolation control module 34 may maintain a plurality of threshold frame interpolation parameters and select the set of threshold parameters that corresponds to the content of the frame. For instance, interpolation control module 34 may select a first set of threshold parameters when a frame that has high motion or high texture and select a second set of threshold parameters for a frame that has low motion or low texture.

As another example, interpolation control module 34 may select whether to enable or disable motion compensated frame interpolation based on the analysis of the content, regularity of the motion field, coding complexity associated with one or more frames, or a combination thereof. Interpolation control module 34 may determine to disable motion compensated frame interpolation when a difference metric between two reference frames, e.g., SAD value, exceeds a threshold. Likewise, interpolation control module 34 may disable motion compensated frame interpolation when the number of moving objects or the sizes of moving objects in two frames is substantially different. Additionally, interpolation control module 34 may indicate to interpolation module 32 to perform frame interpolation using a frame repeat operation or a frame averaging operation.

As a further example, interpolation control module 34 may select a frame prediction mode to use during interpolation based on the analysis of the content, regularity of the motion field, coding complexity associated with one or more frames, or a combination thereof. For example, interpolation control module 34 may select a bi-directional prediction mode when motion vectors associated with moving objects in a previous and subsequent frame are substantially aligned and a difference of the non-zero residue between the moving objects is less than a threshold.

In another aspect of this disclosure, interpolation control module 24 analyzes information for a plurality of video frames received over a period of time, e.g., frames received over a one-second interval. In particular, FIT module 36 generates a FIT table 38 that includes information associated with the plurality of video frames. FIT table 38 may, for example, include information associated with a plurality of frames that form a superframe. As used herein, the term “superframe” refers to a grouping of frames over a period of time. In one example, a superframe may be a grouping of frame over a period of one second. FIT module 36 may generate FIT table 38 to include information such as a frame type of each frame, a frame size of each frame, an error pattern of each frame, an error distribution of each frame, as well as other information associated with each of the frames of the superframe.

Interpolation control module 24 may analyze FIT table 38 and adjust the frame interpolation operation based on the analysis. Interpolation control module 24 may, for example, analyze frame types of the plurality of the frames of the superframe, frame sizes of the plurality of the frames of the superframe, or error distributions associated the plurality of the frames of the superframe, and make an adjustment to the frame interpolation operation based on the analysis. Analysis of FIT table 38 may be particularly useful in determining whether to enable motion compensated frame interpolation. For example, interpolation control module 24 may enable motion compensated frame interpolation if a number of consecutive B-frames exceeds a threshold. As another example, interpolation control module 24 may disable motion compensated frame interpolation if FIT table 38 indicates the reference frame has a large error distribution. In this manner, interpolation control module 24 uses FIT table 38 to select the type of interpolation to use in interpolating a frame of video data.

As described above, interpolation decoder module 24 adjusts the frame interpolation operation based on analysis of any of a number of different types of information associated with one or more frames. Thus, the foregoing techniques may be implemented individually, or two or more of such techniques may be implemented together in interpolation decoder module 24. When interpolation decoder module 24 implements two or more of the techniques together, interpolation decoder module 24 may assign weights to the different types of frame information that is analyzed to prioritize particular types of frame information. In this manner, frame interpolation decoder module 24 may adjust the frame interpolation operation using the frame information deemed to be the most important in making the interpolation adjustment.

Interpolation control module 34 may analyze the information associated with the frames and adjust the frame interpolation operation at various levels or granularities. As an example, interpolation control module 34 may analyze the information associated with the one or more frames and adjust the frame interpolation operation at a frame level. In this case, interpolation decoder module 24 analyzes the information and adjusts the frame interpolation operation for the entire video frame. Alternatively, information decoder module 24 may analyze the information associated with the frames and adjust the frame interpolation operation at a block level. Thus, interpolation decoder module 24 analyzes the information and adjusts the frame interpolation operation only for the particular block associated with the information. As another example, information decoder module 24 may analyze the information associated with the one or more frames and adjust the frame interpolation operation at a region-based level. Interpolation adjustment module 24 may group a plurality of blocks of pixels to form the region and analyze the information associated with all the blocks of pixels in the region. In one aspect, each of the regions of a frame may correspond to a moving object within the frame. In this case, interpolation decoder module 24 analyzes the information and adjusts the frame interpolation operation for all the blocks located within the region.

A number of other elements may also be included interpolation decoder module 24, but are not specifically illustrated in FIG. 2 for simplicity and ease of illustration. The various components illustrated in FIG. 2 may be realized in hardware, software, firmware, or any combination thereof. Some components may be realized as processes or modules executed by one or more microprocessors or digital signal processors (DSPs), one or more application specific integrated circuits (ASICs), one or more field programmable gate arrays (FPGAs), or other equivalent integrated or discrete logic circuitry. Depiction of different features as modules is intended to highlight different functional aspects of interpolation decoder module 24 and does not necessarily imply that such modules must be realized by separate hardware or software components. Rather, functionality associated with one or more modules may be integrated within common or separate hardware or software components. Thus, the disclosure should not be limited to the example of interpolation decoder module 24.

When implemented in software, the functionality ascribed to the systems and devices described in this disclosure may be embodied as instructions on a computer-readable medium, such as within a memory (not shown), which may comprise, for example, random access memory (RAM), read-only memory (ROM), non-volatile random access memory (NVRAM), electrically erasable programmable read-only memory (EEPROM), FLASH memory, magnetic or optical data storage media, or the like. The instructions are executed to support one or more aspects of the functionality described in this disclosure.

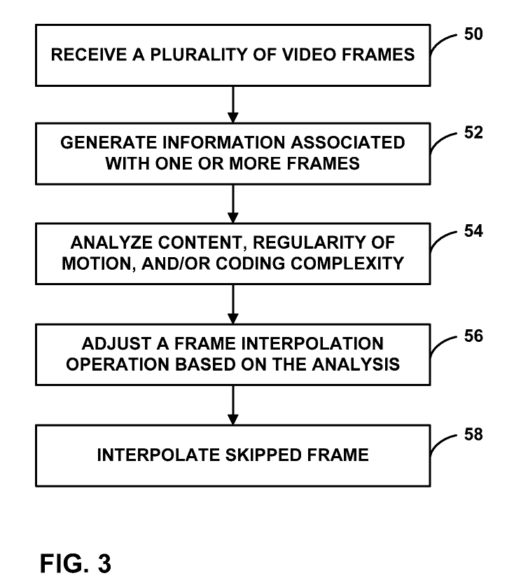

FIG. 3 is a flow diagram illustrating exemplary operation of an interpolation decoder module, such as interpolation decoder module 24 of FIGS. 1 and 2, dynamically adjusting a frame interpolation operation based on analysis of content of one or more video frames, regularity of a motion field between one or more video frames, coding complexity associated with one or more video frames, or a combination thereof. Initially, interpolation decoder module 24 receives a plurality of video frames from encoder 12 (50). As an example, interpolation decoder module 24 may receive a bitstream that carries information associated with the plurality of frames. The information carried over the received bitstream may include, for example, motion vectors associated with one or more blocks of pixels of the frame, block prediction modes, block sub-partitions, coefficients or number of non-zero coefficients within block, skip or direct block numbers, and the like.

In some aspects of this disclosure, interpolation decoder module 24 may generate information associated with one or more frames (52). Frame information generation module 37 may, for example, generate information associated with one or more of the transmitted frames. Alternatively, or additionally, frame information generation module 37 may generate information associated with one or more frames-to-be-interpolated. Frame information generation module 37 may, for example, generate motion vectors, reliability information associated with the motion vectors, prediction modes associated with frames or blocks of pixels within the frame, and the like. Moreover, interpolation decoder module 24 may identify one or more moving objects within the frame and generate information associated with the moving objects, as described above.

Interpolation control module 34 analyzes content of one or more video frames, regularity of a motion field between one or more video frames, coding complexity associated with one or more video frames, or a combination thereof (54). Interpolation control module 34 may, for example, analyze motion within the frames, texture of objects within the frames, types of video in the frames, or the like to determine the content of the frames. In particular, interpolation control module 34 may analyze a motion metric (e.g., one or more motion vectors) and a texture metric (e.g., contrast ratio values). Additionally, interpolation control module 34 may analyze information associated with one or more moving objects within the frames, e.g., the number of moving objects within the frame or frames, the size of the moving objects within the frame or frames, and motion vectors associated with the identified moving objects to determine the content of the frames.

Alternatively, or additionally, interpolation control module 34 may analyze the regularity of the motion field between two or more frames. Interpolation control module 34 may, for example, analyze a difference metric, such as a sum of squares difference (SSD) or a sum of absolute differences (SAD), to determine the motion regularity between one or more frames. Interpolation control module 34 may also compare the number of moving objects or the size of the moving objects in one or more frames to determine the regularity of the motion field between two or more frames. Moreover, interpolation decoder module 24 may also analyze a coding complexity associated with one or more frames. Interpolation control module 34 may, for example, analyze the coefficients provided in the information associated with the frames or the number of non-zero coefficients in the information associated with the frames to determine a coding complexity associated with the frame.

Interpolation control module 34 dynamically adjusts a frame interpolation operation of interpolation module 32 based on the analysis of the content of one or more video frames, the regularity of a motion field between one or more video frames, the coding complexity associated with one or more video frames, or a combination thereof (56). As described above, interpolation control module 34 may adjust the frame interpolation operation in a number of different ways, including selecting whether to enable or disable motion compensated frame interpolation, selecting a different type of interpolation, selecting a video frame prediction mode to be used for frame interpolation, assigning different threshold values for frame interpolation based on the analysis, and a more compute-intensive technique if interpolation is indicated as likely to be more difficult.

Interpolation module 32 interpolates a video frame in accordance with the dynamically adjusted frame interpolation operation (58). For example, interpolation module 32 may interpolate the video frame using the prediction mode selected by interpolation control module 34. As another example, interpolation module 32 may disable motion compensated interpolation, and interpolate the video frame using frame averaging or frame repeat operations instead. As described above, interpolation decoder module 24 may interpolate skipped video frames or insert one or more non-skipped video frames to up-convert the frame rate of the video information.

As described above, interpolation decoder module 24 interpolates video frames and adjusts the interpolation operations at various levels or granularities. In particular, interpolation decoder module 24 may interpolate video frames and adjust the interpolation operations at a frame level, a block level or a region level.

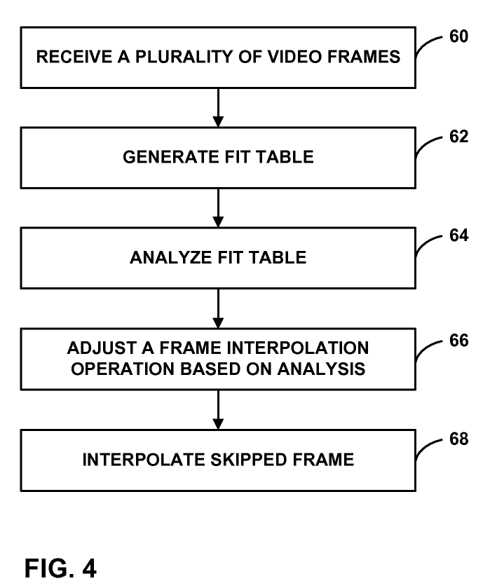

FIG. 4 is a flow diagram illustrating exemplary operation of an interpolation decoder module, such as interpolation decoder module 24 of FIGS. 1 and 2, dynamically adjusting a frame interpolation operation based on analysis of a FIT table 38. Initially, interpolation decoder module 24 receives a plurality of video frames from encoder 12 (60). As an example, interpolation decoder module 24 may receive a bitstream that carries information associated with the plurality of frames.

FIT module 36 generates FIT table 38 (62). FIT module 36 may, for example, analyze portions of the information associated with the plurality of frames and extract particular subsets of information to generate FIT table 38. FIT module 36 may generate FIT table 38 to include information such as a frame type of each frame, a frame size of each frame, an error pattern of each frame, an error distribution of each frame, as well as other information associated with each of the frames of the superframe. As described above, FIT module 36 may generate FIT table 38 to include information for a plurality of video frames received over a period of time, e.g., frames received over a one-second interval. For example, FIT module 36 may generate a FIT table 38 for each received superframe of video data. The term “superframe” refers to a grouping of a plurality of frames over a period of time.

Interpolation control module 34 analyzes information contained in FIT table 38 and adjusts a frame interpolation operation based on the analysis (64, 66). Interpolation control module 24 may, for example, analyze frame types associated with a plurality of frames and enable motion compensated frame interpolation if a number of consecutive B-frames exceeds a threshold, which may indicate a smooth motion field.

As another example, interpolation control module 34 may analyze frame sizes of a plurality of frames and adjust the frame interpolation operation based on the frame sizes. Frame size may be an indication of complexity of a frame in terms of both motion complexity and texture complexity. Interpolation control module 34 may, for instance, determine whether to enable or disable motion compensated frame interpolation based whether to perform frame interpolation based on the frame size. In particular, interpolation control module 34 may disable motion compensated frame interpolation when the frame sizes of the plurality of frames vary significantly (e.g., exceeds a threshold).

As a further example, interpolation control module 34 may analyze and adjust the frame interpolation operation based on an error distribution of one or more frames. Motion compensated frame interpolation may be highly dependent on the correctly decoding of the reference frames and, thus, interpolation control module 34 may disable motion compensated frame interpolation when an error distribution associated with one or more reference frames is above a threshold error distribution value.

In some aspects, interpolation control module 34 may adaptively determine whether to enable frame interpolation based on a decoding complexity and remaining computational resources of decoder 14. For example, interpolation control module 34 may enable frame interpolation when the computational resources of decoder 14 are running behind. Interpolation control module 34 may analyze frame size (both motion information and residual information) as well as frame type to determine decoding complexity and remaining computational resources of decoder 14. For example, a B-frame may be considered more complex than a P-frame of the same frame size because the B-frame requires more computational resources due to its bi-directional motion compensation features. Interpolation control module 34 may interpolate a frame instead of performing normal B-frame decoding when computational resources of decoder 14 are running behind. In some implementations, interpolating a video frame may be less computationally expensive compared with normal B-frame decoding when frame interpolation operations are dedicated to a digital signal processor (DSP) part of a mobile station modem (MSM) platform.

Interpolation module 32 interpolates a video frame in accordance with the dynamically adjusted frame interpolation operation (68). For example, interpolation module 32 may disable motion compensated interpolation, and interpolate the video frame using frame averaging or frame repeat operations instead. As another example, interpolation module 32 may interpolate the video frame using the prediction mode selected by interpolation control module 34.

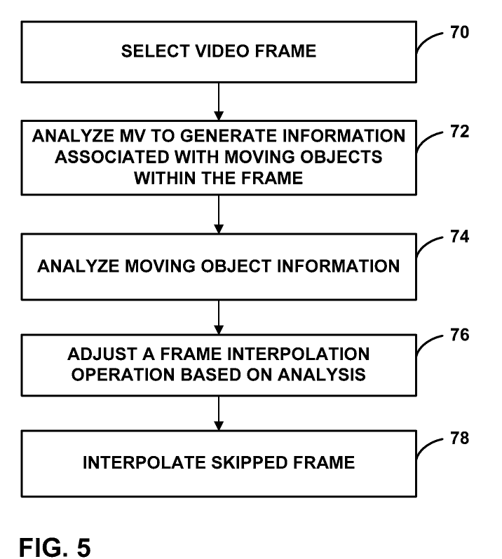

FIG. 5 is a flow diagram illustrating exemplary operation of interpolation decoder module 24 adjusting a frame interpolation operation based on an analysis of moving objects within one or more video frames. Initially, interpolation decoder module 24 selects a video frame (70). Interpolation decoder module 24 may select a reference video frame, e.g., a previous or subsequent video frame, or select a frame-to-be-interpolated.

Interpolation decoder module 24 analyzes motion vectors associated with one or more blocks of pixels in the selected video frame to generate information associated with one or more moving objects within the frame (72). As described above, interpolation decoder module 24 may include a moving object detection module 40 that analyzes motion vectors (MVs) associated with the frame and identifies one or more moving objects within the frame. In particular, moving object detection module 40 may group blocks of pixels within a region that have substantially similar motion vectors to detect moving objects in accordance with the techniques described herein. For example, moving object detection module 40 may select a first block of pixels within the frame, compare the motion vector associated with the first block of pixels with motion information associated with one or more neighboring pixels that surround the selected block of pixels, and group the first block of pixels with the neighboring blocks of pixels that have substantially similar motion information.

Moving object detection module 40 may then perform a similar analysis for each of the neighboring blocks of pixels that belong to that object until all blocks of pixels in that region that have substantially similar motion vectors are grouped to form the moving object. Moving object detection module 40 may then begin to analyze other blocks of pixels with different motion vectors to detect other moving objects in the frame in a similar manner. Moreover, moving object detection module 40 may merge the motion vectors of the blocks of pixels that form the objects to generate a single motion vector that corresponds to the moving object. In this manner, moving object detection module 40 generates information that identifies the number of moving objects within the frame, the size of the moving objects (e.g., in terms of the number of blocks in the moving object), motion information associated with one or more of the moving objects, and the like.

As described above, moving object detection module 40 may generate information associated with moving objects in a reference frame or in a frame-to-be-interpolated. When moving object detection module 40 generates information associated with moving objects for a skipped frame, for example, the information is generated after motion vectors are assigned to the skipped frame. Additionally, in some aspects, moving object detection module 40 may have to account for more than one set of motion vectors. For instance, moving object detection module 40 may have to account for both forward and backward motion vectors.

Interpolation control module 34 analyzes the generated moving object information associated with one or more frames (74). Interpolation decoder module 34 may, for example, compare the number of moving objects in each of the frames, the size of the moving objects in each the frames, the motion information associated with the moving objects in each of the frames or the like. Interpolation control module 34 may, for example, compare the moving object information associated with one or more reference frames. Alternatively, or additionally, interpolation control module 34 may analyze the moving object information associated with a skipped frame. Moreover, interpolation control module 34 may analyze the moving object information associated with the entire frame (e.g., associated with all the moving objects). Alternatively, interpolation control module 34 may analyze the moving object information associated with individual moving objects within the frame.

Interpolation control module 34 adjusts a frame interpolation operation based on the analysis of the moving objects within one or more of the frames (76). As an example, interpolation control module 34 may select a prediction mode, e.g., a forward prediction, backward prediction mode, or a bi-directional prediction mode, that will result in the best interpolation operation. Interpolation control module 34 may adjust the frame interpolation operation on a frame level (e.g., for all blocks of the frame) or on a moving object level (e.g., for a group of blocks). For example, interpolation control module 34 may adjust a prediction mode for the entire frame based on analysis of information associated with moving objects in one or more reference frames. In particular, interpolation control module 34 may compare the number of moving objects in a previous and subsequent reference frame and select a prediction mode for the entire frame that uses the reference frame with the least amount of moving objects. In this manner, the prediction mode decision is adjusted according to the comparison between moving object numbers associated with each reference frame.

As another example, interpolation control module 34 compares normalized non-zero coefficients of moving objects between previous and subsequent reference frames to select a frame prediction mode. Normalized non-zero coefficients of moving objects are used to determine the reliability of the moving objects. Smaller non-zero coefficients indicate a more reliable moving object. Thus, if both reference frames have the same number of moving objects and the sizes of the moving objects are roughly the same, then interpolation control module may select the prediction mode that uses the reference frame with overall smaller normalized non-zero coefficients for interpolation.

In a further example, interpolation control module 34 may select a prediction mode for blocks of pixels associated with a moving object based on information associated with the moving object. Interpolation control module 34 may, for example, select a bi-directional prediction mode for interpolation of the blocks of pixels associated with the moving objects when motion vectors associated with a corresponding moving object in a previous and subsequent reference frame are aligned, and the difference of the non-zero residue between the moving objects of the reference frames is less than a threshold. Interpolation control module 34 may determine that the motion vectors associated with the moving objects in the reference frame are aligned when the motion vectors are pointing toward each other and the overlapping portion of the moving objects exceeds a predetermined threshold. When the motion vectors associated with a corresponding moving object in a previous and subsequent reference frame are not aligned or the difference of the non-zero residue between the moving objects of the reference frames is greater than a threshold, interpolation control module 34 selects a prediction mode for the moving object that uses the one of the reference frames that includes a majority of the moving object of the frame-to-be-interpolated. Interpolation control module 34 may make similar frame level and moving object level prediction mode decisions based on analysis of information associated with one or more moving objects in the frame-to-be-interpolated.

Interpolation module 32 interpolates a video frame in accordance with the dynamically adjusted frame interpolation operation (78). For example, interpolation module 32 may disable motion compensated interpolation, and interpolate the video frame using frame averaging or frame repeat operations instead. As another example, interpolation module 32 may interpolate the frame using the prediction mode selected by interpolation control module 34.

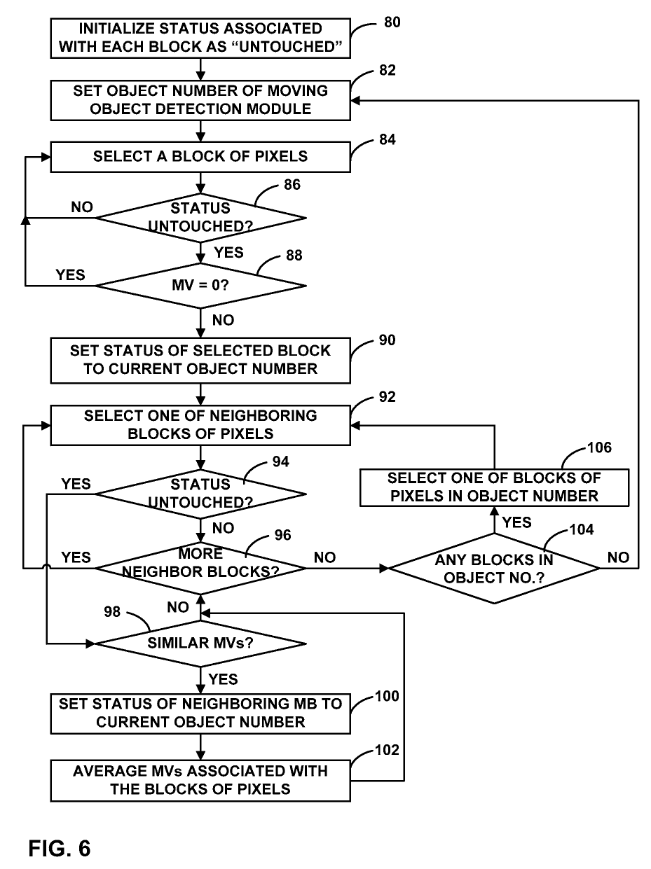

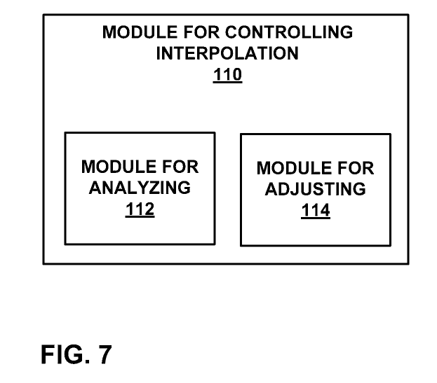

FIG. 6 is a flow diagram illustrating exemplary operation of moving object detection module 40 analyzing block information associated with blocks of pixels of a frame to detect moving objects in the frame. As described above, the moving object detection techniques described herein may be used to detect moving objects in one or more reference frames or in a frame-to-be-interpolated. Initially, moving object detection module 40 initializes a status associated with each of the blocks of pixels in the frame as “untouched” (80). A status of “untouched” means that moving object detection module 40 has not associated the block of pixels with a moving object. Moving object detection module 40 sets an object number equal to one (82). The object number corresponds with the moving object that moving object detection module 40 is currently detecting.

Moving object detection module 40 selects a block of pixels in the frame (84). The selected block of pixels is the starting point for the moving object analysis. Moving object detection module 40 checks the status associated with the selected block of pixels to determine if the status associated with the block is “untouched” (86). If the status associated with the selected block of pixels is not “untouched,” moving object detection module 40 selects the next block of pixels to analyze. If the status associated with the selected block of pixels is “untouched,” moving object detection module 40 determines whether the motion vector associated with the selected block of pixels is equal to zero (88). If the motion vector associated with the selected block of pixels is equal to zero, the block of pixels is not associated with any moving object. Therefore, moving object detection module 40 selects the next block of pixels to analyze. Additionally, moving object detection module 40 may set the status of the block to a number that does not correspond to any moving object, such as zero. By setting the status of the block to zero, moving object detection module 40 does not need to analyze the block again.

If the motion vector associated with the selected block of pixels is not equal to zero, moving object detection module 40 sets the status associated with the selected block of pixels equal to the current object number (90). In this case, the status associated with the selected block of pixels would be set equal to one. If moving object detection module 40 had already detected one or more moving objects, the status would be set to whatever number moving object is currently being detected.

Moving object detection module 40 begins to analyze the motion information associated with the blocks of pixels surrounding the selected block of pixels, referred to herein as neighboring blocks of pixels. Moving object detection module 40 may, for example, analyze motion information associated with a three block by three block section of the frame that surrounds the selected block. Although the techniques are described in terms of a three block by three block window, the techniques may also be utilized to analyze different sized neighboring block windows.

In particular, moving object detection module 40 selects a first one of the neighboring blocks of pixels (92). Moving object detection module 40 checks the status associated with the neighboring block of pixels to determine if the status associated with the block is “untouched” (94). If the status associated with the selected block of pixels is not “untouched,” moving object detection module 40 determines whether there are any other neighboring blocks of pixels in the three block by three block window that have not yet been analyzed (96). If there are more neighboring pixels within the window, moving object detection module selects another one of the pixels (92).

If the status associated with the selected block of pixels is “untouched,” moving object detection module 40 compares a motion vector associated with the selected block of pixels with a motion vector associated with the neighboring block of pixels to determine whether the motion vectors are substantially similar (98). Moving object detection module 40 may compare the motion vectors of the selected block and the neighboring blocks of pixels in terms of magnitude, direction or both magnitude and direction. Moving object detection module 40 may, for example, compute a difference in magnitude and direction and compare the computed difference to a threshold value. If the motion vectors associated with the selected block and the neighboring block are not substantially similar, moving object detection module 40 determines whether there are any other neighboring blocks of pixels in the three block by three block window that have not yet been analyzed (96). If there are more neighboring pixels within the window, moving object detection module selects another one of the pixels (92).

If the motion vectors of the selected block and neighboring block are substantially similar, moving object detection module 40 sets the status associated with the selected neighboring block of pixels to the current object number (100). In this manner, moving object detection module 40 identifies that the block and its neighboring block both belong to the same moving object. Moving object detection module 40 may also average the motion vectors associated with the blocks of pixels having the same object number (102). Moving object detection module 40 continues to analyze the neighboring blocks in a similar fashion until all the neighboring blocks in the three block by three block window have been analyzed.

Once moving object detection module 40 has analyzed all the neighboring blocks in the three block by three block window, moving object detection module 40 identifies whether there are any neighboring blocks that belong to the current object (104). Moving object detection module 40 may, for example, identify the neighboring blocks that have a status equal to the current object number. If there are any neighboring blocks that belong to the current object, moving object detection module 40 selects one of the identified blocks and analyzes the blocks of pixels that neighbor the selected blocks of pixels in the same manner described above. Moving object detection module 40 continues to analyze each of the blocks of pixels belonging the current object until all the blocks of pixels associated with the current object have been analyzed. In this manner, moving object detection module 40 groups adjacent blocks of pixels with substantially similar motion vectors to generate and detect moving objects within the video frame.

Once moving object detection module 40 has analyzed all the blocks of pixels belonging the current object, moving object detection module 40 increments the object number and begins to analyze the remaining blocks of pixels of the frame in the same manner as described above (82). In other words, moving object detection module 40 begins to analyze the blocks of pixels that have motion vectors that are not substantially similar to the initially selected block of pixels.

In this manner, moving object detection module 40 may analyze the motion vectors associated with a plurality of blocks of pixels in the frame to detect one or more moving objects within the frame. Based on this analysis, moving object detection module 40 may identify the number of moving objects within the frame, the size of the moving objects in the frame (i.e., the number of blocks of pixels associated with the moving object, and motion information associated with each of the moving objects. Moving object detection module 40 may provide this information to interpolation control module 34 to analyze for making adjustments to the frame interpolation operation.

Although the moving object detection techniques are described in the context of detecting moving objects for analyzing to make frame interpolation adjustments, the moving object detection techniques may also be used for other encoding and decoding purposes.

FIG. 7 is a block diagram illustrating an exemplary module for controlling interpolation 110. Module for controlling interpolation 110 includes a module for analyzing 112 and a module for adjusting 114. The modules illustrated in FIG. 8 operate together to dynamically adjust a frame interpolation operation. More specifically, module for analyzing 112 analyzes information associated with at least one video frame and dynamically adjusts the frame interpolation based on the analysis. Module for analyzing 112 may, for example, analyze content of one or more video frames, regularity of a motion field between two or more video frames, a coding complexity associated with one or more video frames, or a combination thereof. In one example, module for analyzing 112 may analyze information associated with one or more reference frames that are used to interpolate a video frame. Alternatively, or additionally, module for analyzing 112 may analyze information associated with a frame-to-be-interpolated, such as a skipped video frame. Module for analyzing 112 may also analyze information for a plurality of frames received over a period of time, e.g., frames received over a one-second interval.

Module for adjusting 114 dynamically adjusts a frame interpolation operation based on the analysis of the information associated with the one or more video frames. Module for adjusting 114 may adjust the frame interpolation operation in number of different manners. As an example, module for adjusting 114 may select whether to enable or disable motion compensated frame interpolation. When motion compensated frame interpolation is disabled, module for adjusting 114 additionally select a different frame interpolation operation, such as a frame repeat or a frame average operation. As another example, module for adjusting 114 may select a video frame prediction mode to be used for frame interpolation based on the analysis. In a further example, module for adjusting 114 may assign different threshold values for frame interpolation based on the analysis.

In accordance with this disclosure, means for analyzing information associated with a video frame may comprise interpolation decoder module 24 (FIG. 1), interpolation control module 34 (FIG. 2), module for controlling interpolation 110 (FIG. 8) or module for analyzing 112 (FIG. 7). Similarly, means for dynamically adjusting a frame interpolation operation based on the analysis of the information may comprise interpolation decoder module 24 (FIG. 1), interpolation control module 34 (FIG. 2), module for controlling interpolation 110 (FIG. 8), or module for adjusting 114 (FIG. 7). Although the above examples are provided for purposes of illustration, the disclosure may include other instances of structure that corresponds to respective means.

The techniques described herein may be implemented in hardware, software, firmware, or any combination thereof. If implemented in hardware, the techniques may be realized using digital hardware, analog hardware or a combination thereof. If implemented in software, the techniques may be realized at least in part by one or more stored or transmitted instructions or code on a computer-readable medium. Computer-readable media may include computer storage media, communication media, or both, and may include any medium that facilitates transfer of a computer program from one place to another. A storage media may be any available media that can be accessed by a computer.

By way of example, and not limitation, such computer-readable media can comprise RAM, such as synchronous dynamic random access memory (SDRAM), read-only memory (ROM), non-volatile random access memory (NVRAM), ROM, electrically erasable programmable read-only memory (EEPROM), EEPROM, FLASH memory, CD-ROM or other optical disk storage, magnetic disk storage or other magnetic storage devices, or any other medium that can be used to carry or store desired program code in the form of instructions or data structures and that can be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically, e.g., with lasers. Combinations of the above should also be included within the scope of computer-readable media.

A computer program product, as disclosed herein, includes a computer-readable medium as well as any materials associated with the computer-readable medium, including packaging materials within which the computer-readable medium is packaged. The code associated with a computer-readable medium of a computer program product may be executed by a computer, e.g., by one or more processors, such as one or more digital signal processors (DSPs), general purpose microprocessors, application specific integrated circuits (ASICs), field programmable logic arrays (FPGAs), or other equivalent integrated or discrete logic circuitry. In some aspects, the functionality described herein may be provided within dedicated software modules or hardware modules configured for encoding and decoding, or incorporated in a combined video encoder-decoder (CODEC).

Various aspects have been described. These and other aspects are within the scope of the following claims.

1. A method for processing digital video data, the method comprising:
analyzing information associated with at least one video frame; and
dynamically adjusting a frame interpolation operation based on the analysis of the information.

2. The method of claim 1, wherein the analysis comprises analyzing at least one of content of the video frame, regularity of a motion field between the video frame and one or more other video frames, and a coding complexity associated with the video frame.

3. The method of claim 1, further comprising:
generating a frame information table (FIT) that includes information for a plurality of video frames,
wherein the analysis comprises analyzing the FIT table associated with the plurality of video frames.

4. The method of claim 1, wherein the dynamic adjustment comprises selecting whether to enable or disable motion compensated video frame interpolation.

5. The method of claim 1, wherein the dynamic adjustment comprises selecting a video frame prediction mode.

6. The method of claim 5, wherein the selection comprises selecting one of a forward prediction mode, a backward prediction mode and a bi-directional prediction mode.

7. The method of claim 1, wherein the dynamic adjustment comprises assigning threshold values for frame interpolation.

8. The method of claim 1, further comprising:
grouping blocks of pixels having substantially similar motion information to detect one or more moving objects within the video frame; and
merging the motion information associated with each of the blocks of pixels of the grouping to generate motion information for the detected moving object,
wherein the analysis comprises analyzing the information associated with the detected moving objects.

9. The method of claim 8, further comprising:
selecting a first block of pixels within the video frame;
comparing at least one of a magnitude and direction of a motion vector associated with the first block of pixels with one of a magnitude and direction of motion vectors associated with a plurality of neighboring blocks of pixels within the video frame;
classifying the motion vectors as substantially similar if the comparison is less than a threshold; and
grouping the first block of pixels with the ones of the neighboring blocks of pixels that have substantially similar motion information to generate motion information for the moving objects.

10. The method of claim 9, further comprising:
selecting a second block of pixels within the video frame, wherein the second block of pixels is one of the neighboring blocks of pixels that has substantially similar motion information to the first block of pixels;
comparing a motion vector associated with the second block of pixels with motion vectors associated with a plurality of blocks of pixels that neighbor the second block of pixels; and
grouping the second block of pixels with the ones of the blocks of pixels that neighbor the second block of pixels that have substantially similar motion information.

11. The method of claim 8, wherein the dynamic adjustment comprises:
selecting a reference frame based on the analysis of the information associated with the detected moving objects; and
selecting a frame prediction mode based on the selected reference frame.

12. The method of claim 11, wherein the reference frame selection comprises selecting a reference frame with one of a smallest number of moving objects and a smallest size moving object.

13. The method of claim 1, wherein the dynamic adjustment comprises one of adjusting the frame interpolation operation for the entire video frame and adjusting the frame interpolation operation for a portion of the video frame.

14. The method of claim 1, wherein the analysis comprises analyzing information associated with one or more reference frames used to interpolate a skipped video frame.

15. The method of claim 1, wherein the analysis comprises analyzing information associated with a skipped video frame.

16. An apparatus for processing digital video data, the apparatus comprising:
an analysis module that analyzes information associated with at least one video frame; and
an adjustment module that dynamically adjusts a frame interpolation operation based on the analysis of the information.

17. The apparatus of claim 16, wherein the analysis module analyzes at least one of content of the video frame, regularity of a motion field between the video frame and one or more other video frames, and a coding complexity associated with the video frame.

18. The apparatus of claim 16, further comprising:
a frame information table (FIT) module that generates a FIT table that includes information for a plurality of video frames,
wherein the analysis module analyzes the FIT table associated with the plurality of video frames.

19. The apparatus of claim 16, wherein the adjustment module selects whether to enable or disable motion compensated video frame interpolation.

20. The apparatus of claim 16, wherein the adjustment module selects a video frame prediction mode.

21. The apparatus of claim 20, wherein the video frame prediction mode comprises one of a forward prediction mode, a backward prediction mode and a bi-directional prediction mode.

22. The apparatus of claim 16, wherein the adjustment module assigns threshold values for frame interpolation.

23. The apparatus of claim 16, further comprising:
a moving object detection module that groups blocks of pixels having substantially similar motion information to detect one or more moving objects within the video frame and merges the motion information associated with the blocks of pixels of the grouping to generate motion information associated with the detected moving objects,
wherein the analysis module analyzes the information associated with the detected moving objects.

24. The apparatus of claim 23, wherein the moving object detection module selects a first block of pixels within the video frame, compares at least one of a magnitude and direction of a motion vector associated with the first block of pixels with one of a magnitude and direction of motion vectors associated with a plurality of neighboring blocks of pixels within the video frame, classifies the motion vectors as substantially similar if the comparison is less than a threshold, and groups the first block of pixels with the ones of the neighboring blocks of pixels that have substantially similar motion information to generate the moving objects.

25. The apparatus of claim 24, wherein the moving object detection module selects a second block of pixels within the video frame, wherein the second block of pixels is one of the neighboring blocks of pixels that has substantially similar motion information to the first block of pixels, compares a motion vector associated with the second block of pixels with motion vectors associated with a plurality of blocks of pixels that neighbor the second block of pixels, and groups the second block of pixels with the ones of the blocks of pixels that neighbor the second block of pixels that have substantially similar motion vectors.

26. The apparatus of claim 23, wherein the adjustment module selects a reference frame based on the analysis of the information associated with the detected moving objects and selects a frame prediction mode based on the selected reference frame.

27. The apparatus of claim 26, wherein the adjustment module selects the reference frame with one of a smallest number of moving objects and a smallest size moving object.

28. The apparatus of claim 16, wherein the adjustment module adjusts the frame interpolation operation for a portion of the video frame.

29. The apparatus of claim 16, wherein the analysis module analyzes information associated with one or more reference frames used to interpolate a skipped video frame.

30. The apparatus of claim 16, wherein the analysis module analyzes information associated with a skipped video frame.

31. An apparatus for processing digital video data, the apparatus comprising:
means for analyzing information associated with a video frame; and
means for dynamically adjusting a frame interpolation operation based on the analysis of the information.

32. The apparatus of claim 31, wherein the analyzing means analyzes at least one of content of the video frame, regularity of a motion field between the video frame and one or more other video frames, and a coding complexity associated with the video frame.

33. The apparatus of claim 31, further comprising:
means for generating a frame information table (FIT) that includes information for a plurality of video frames, and
wherein the analyzing means analyzes the FIT table associated with the plurality of video frames.

34. The apparatus of claim 31, wherein the adjusting means selects whether to enable or disable motion compensated video frame interpolation.

35. The apparatus of claim 31, wherein the adjusting means selects a frame prediction mode.

36. The apparatus of claim 35, wherein the frame prediction mode comprises one of a forward prediction mode, a backward prediction mode and a bi-directional prediction mode.

37. The apparatus of claim 31, wherein the adjusting means assigns threshold values for frame interpolation.

38. The apparatus of claim 31, further comprising:
means for grouping blocks of pixels having substantially similar motion information to detect one or more moving objects within the video frame; and
means for merging the motion information associated with each of the blocks of pixels of the grouping to generate motion information for the detected moving objects,
wherein the analyzing means analyzes the information associated with the detected moving objects.

39. The apparatus of claim 38, further comprising:
means for selecting a first block of pixels within the video frame;
means for comparing at least one of a magnitude and direction of a motion vector associated with the first block of pixels with one of a magnitude and direction of motion vectors associated with a plurality of neighboring blocks of pixels within the video frame and classifying the motion vectors as substantially similar if the comparison is less than a threshold; and
means for grouping the first block of pixels with the ones of the neighboring blocks of pixels that have substantially similar motion information to generate motion information for the moving objects.

40. The apparatus of claim 39, wherein:
the selecting means selects a second block of pixels within the video frame, wherein the second block of pixels is one of the neighboring blocks of pixels that has substantially similar motion information to the first block of pixels;
the comparing means compares motion information associated with the second block of pixels with motion information associated with a plurality of blocks of pixels that neighbor the second block of pixels; and
the grouping means groups the second block of pixels with the ones of the blocks of pixels that neighbor the second block of pixels that have substantially similar motion information.

41. The apparatus of claim 38, wherein the adjusting means selects a reference frame based on the analysis of the information associated with the detected moving objects and selects a frame prediction mode based on the selected reference frame.

42. The apparatus of claim 41, wherein the selecting means selects a reference frame with one of a smallest number of moving objects and a smallest size moving object.

43. The apparatus of claim 31, wherein the adjusting means adjusts one of the frame interpolation operation for the entire video frame and the frame interpolation operation for a portion of the video frame.

44. The apparatus of claim 31, wherein the analyzing means analyzes information associated with one or more reference frames used to interpolate a skipped video frame.

45. The apparatus of claim 31, wherein the analyzing means analyzes information associated with a skipped video frame.

46. A processor for processing digital video data, the processor being adapted to:
analyze information associated with at least one video frame; and
dynamically adjust a frame interpolation operation based on the analysis of the information.

47. A computer-program product for processing digital video data comprising:
a computer readable medium comprising codes for causing at least one computer to:
analyze information associated with at least one video frame; and
dynamically adjust a frame interpolation operation based on the analysis of the information.
